(19) United States
(12) Patent Application Publication
(10) Pub. No.: US 2008/0272974 A1
(43) Pub. Date: Nov. 6, 2008

(54) Multiband planar antenna and electrical apparatus using the same

(75) Inventor: Chih-Wei Chang, Taipei (TW)

Correspondence Address: BACON & THOMAS, PLLC, 625 SLATERS LANE, FOURTH FLOOR, ALEXANDRIA, VA, 22314-1176, US

(73) Assignee: CLEVO CO., Sunchung (TW)

(21) Appl. No.: 12/149,548

(22) Filed: May 5, 2008

(30) Foreign Application Priority Data
May 4, 2007 (TW) 96115876

(51) Int. Cl. H01Q 13/10; H01Q 9/04

(52) U.S. Cl. 343/770; 343/700 MS

(57) ABSTRACT

A multi-band planar antenna including a metal plate, a first radiation portion, a second radiation portion, and a grounding portion is provided. The plate includes a first and a second edge. The first radiation portion is configured on the upper of the plate by a first slot, and the first slot extends to the inner of the plate from the first edge. The second radiation portion is configured on the upper side of the plate adjacent to the second edge by a second slot and a third slot adjacent to the first radiation portion. The second slot extends to the inner of the metal plate from the second edge. The third slot is formed between the first and the second slot. The grounding portion is formed on the lower of the metal plate. The first and the second radiation portion transmit and receive the low-band and high-band of RF signal respectively.

### FIELD OF THE INVENTION

The invention provides an apparatus of an antenna, especially a multi-band planar antenna.

### BACKGROUND OF THE INVENTION

The rapid growth of the wireless communication technology and the maturated 3^{rd} generation portable wireless technology resulted to the trend of the integration of multi-band signal processing circuitry into the portable electronic devices, such as the wireless portable device, personal digital assistant and computer. The integration of multi-band signal processing circuitry enables the electronic devices to support multi-band portable network. Antenna, as a component to transmit and receive wireless signals is one of the key components of the above apparatus. The size of the antenna will need to be reduced to fulfill the trend to the slimmer and more compact design of the electronic devices.

The planar inverted-F antenna is widely applied to the communication system of the high-end electronic devices, due to its simple structure, ease of design and good antenna characteristics. FIG. 1 illustrates the common planar inverted-F antenna structure of the related art. As illustrated in FIG. 1, planar inverted-F antenna 10 comprising a first metal plate 12 as the radiation portion, second metal plate 14 as ground portion and third metal plate as short circuit portion. Based on the concept of common planar inverted-F antenna, many types of planar inverted-F antenna have been introduced to cater for devices with different mechanical and electrical characteristics. For example, each U.S. Pat. No. 7,161,541 and U.S. Pat. No. 7,015,863 revealed the structure of multi-band planar inverted-F antenna.

However, the 3-dimensional structure of the planar inverted-F antenna, which is needed to transmit and receive signals, becomes a limitation to the integration of varies electronic devices and the antenna. Varies electronic devices has different expectation to the size and outlook of the antenna; Also, planar inverted-F antenna needs high frequency inductive reactance and capacitive reactance to transmit and receive RF signals. Thus, resizing any part of the planar inverted-F antenna, such as changing the distance between the first metal plate 12 and the second metal plate 14, will change the capacitance of the antenna, consequently causing the differences in frequency response. Therefore, a same 3-dimensional planar inverted-F antenna cannot be applied into different electronic devices.

In the related art, for the same band, different antenna structures need to be designed to fulfill the requirement of the antenna size and structure from varies electronic devices. Therefore, the cost of the antenna design, and the cost of different molds to manufacture different antenna structures will increase the product manufacturing cost, consequently reduce the profit of the products. Thus, the present invention helps to reduce the manufacturing cost of the products to raise the product's competitiveness.

### SUMMARY OF THE INVENTION

Present invention provides the apparatus of a multi-band planar antenna, and also provides the method to configure the multi-band planar antenna. The multi-band planar antenna is formed as a metal plate; therefore, it's easy to be integrated with the structure of electronic devices. The size of the grounding section of the antenna can be adjusted so that it can fits into different electronic devices.

The multi-band planar antenna revealed in present invention comprising a metal plate, a first radiation conductor, second radiation conductor and a grounding conductor. The metal plate comprises of a first edge and a second edge, and the first edge and the second edge is configured at each side of the metal plate respectively. The first radiation portion is configured on the upper of the metal plate by the first slot, and the first slot extends to the inner of the metal plate from the first edge. The second radiation portion is configured on the upper side of the metal plate adjacent to the second edge by a second slot and a third slot adjacent to the first radiation portion. The second slot extends to the inner of the plate from the second edge. The third slot is formed between the first and the second slot. The grounding portion is formed on the lower of the plate. The first and the second radiation portion transmit and receive the low-band and the high-band of RF signal respectively.

Present invention also revealed an electronic apparatus, having the multi-band planar antenna from the present invention configured internally. Furthermore, present invention also provides a method to adjust the size of the multi-band planar antenna. The size of the multi-band planar antenna from the present invention can be adjusted by adjusting the size of its grounding portion.

### BRIEF DESCRIPTION OF THE DRAWINGS

FIG. 1 illustrates an embodiment of the related prior art.

FIG. 2 illustrates the embodiment in accordance with the present invention.

FIG. 3 illustrates the feeding dot of the embodiment in accordance with the present invention.

FIG. 4A and FIG. 4B illustrates the structure diagram of the embodiment in accordance with the present invention.

FIG. 5 illustrates the frequency gain relations diagram of the embodiment in accordance with the present invention.

FIG. 6 and FIG. 7 each illustrate the embodiment of an electronic device in accordance with the present invention.

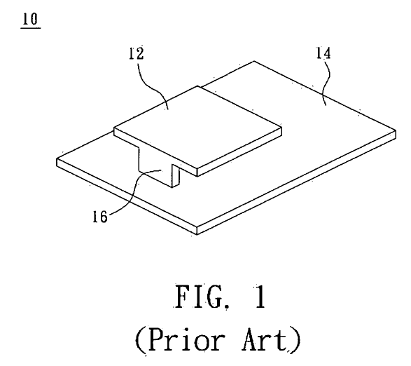

### DESCRIPTION OF THE PREFERRED EMBODIMENTS

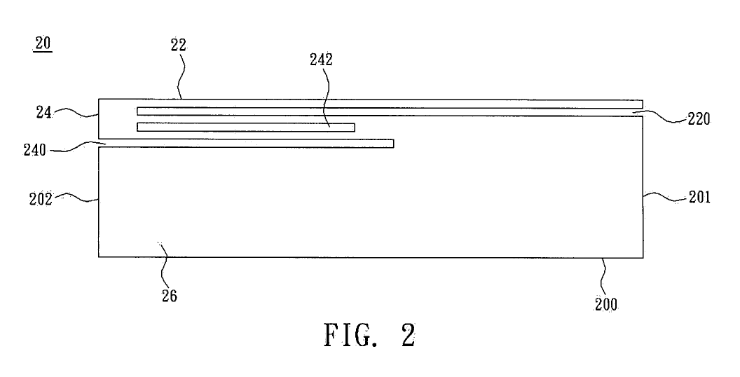

FIG. 2 revealed the structure diagram of one of the embodiment in accordance with the present invention. As illustrated in FIG. 2, the multi-band planar antenna comprising of a metal plate 200, a first radiation portion 22, a second radiation portion 24 and a grounding portion 26. The first radiation portion 22, second radiation portion 24 and the grounding portion 26 is positioned on metal plate 200. The second radiation portion is adjacent to the first radiation portion 22, and the grounding portion 26 is formed at the lower of metal plate 200 adjacent to the second radiation portion 24.

As illustrated in FIG. 2, metal plate 200 is formed as a structure of rectangle. The first edge 201 and the second edge 202 are positioned at 2 sides of metal plate 200 respectively, and the second edge 202 is facing to the first edge 201. The first radiation portion 22 comprises of a first slot 220, and a first radiation portion 22 formed on the upper of the metal plate 200 by the first slot 220. The first slot 220 extends to the inner of the metal plate 200 through first edge 201, and formed an aperture on the first edge 201.

The second radiation portion 24 comprises a second slot 240 and a third slot 242. The second radiation portion 24 is configured on the upper side of the metal plate 200 adjacent to the second edge 202 by a second slot 240 and a third slot 242. The second slot 240 extends to the inner of the plate from the second edge 202, and form an aperture on the second edge 202. The third slot 242 is formed between the first slot 220 and the second slot 240.

The first radiation portion 22 and the second radiation portion 24 is the structure of the multi-band planar antenna 20 to transmit and receive RF signal. The first radiation portion 22 and the second radiation portion 24 transmit and receive the low-band and the high-band of RF signal respectively. The said low-band RF signal channel comprises of GSM (Global System for Mobile Communication) 900 MHz, and the high-band RF signal channel comprises of GSM 1800 MHz, GSM 1900 MHz and WCDMA (Wideband Code Division Multiple Access) 2100 MHz.

In order to achieve the high frequency RF characteristic, as illustrated in FIG. 2, the first slot 220, the second slot 240 and the third slot 242 are parallel narrow and long slots. And the slots 220, 240 and 242 are positioned in a straight line on the first edge 201 and the second edge 202. The shape, size and the distance between the metal plate 200, the first slot 220, the second slot 240, and the third slot 242 need to be analyzed and obtained by using the high frequency electromagnetic simulation software, based on the requirement from different frequency band.

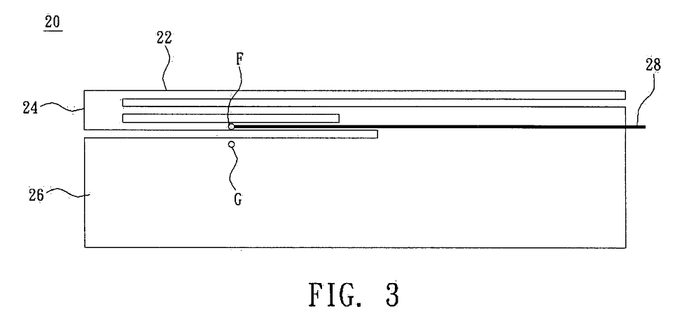

FIG. 3 illustrates the feeding dot F and the grounding dot G of the multi-band planar antenna 20 in accordance to present invention. The feeding dot F is positioned between second slot 240 and third slot 242. The feeding dot F shown in FIG. 3 is a better position in the multi-band planar antenna 20 to transmit and receive RF signals. The RF signals are being transmitted and received by using a connector 28, which is matching to the RF signal resistance. The grounding dot G is the grounding conductor of the multi-band planar antenna 20. The grounding dot G can be in any position of the grounding portion 26. The position of the grounding dot G as illustrated in the diagram is only serves as an example.

Multi-band planar antenna 20 is suitable to be embedded into the shell of an electronic device. As the multi-band planar antenna 20 is formed on the surface of a single metal plate 200, thus, it's easy to be assembled with the electronic device structures. The feeding dot F of the multi-band antenna is configured to the RF signal processing circuit of the electronic device, while the ground point G of the multi-band antenna is configured to the grounding conductor of the electronic device.

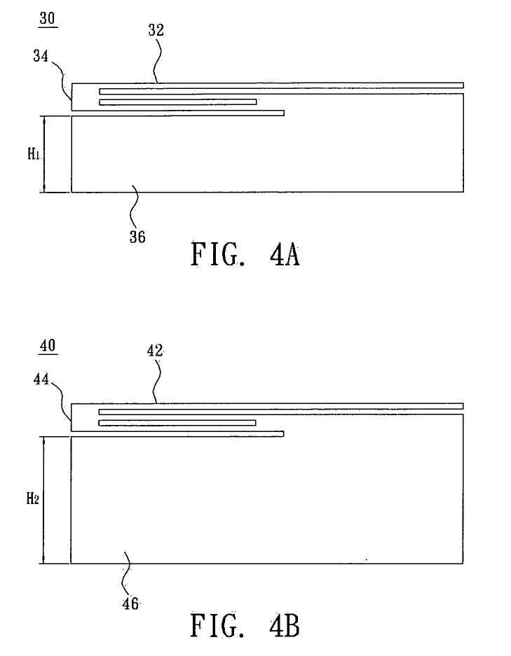

The overall size of the multi-band planar antenna 20 in present invention can be adjusted by adjusting the size of the grounding portion 26. FIG. 4A and FIG. 4B illustrates the structure diagram of the embodiment. Each of FIG. 4A and FIG. 4B also illustrates the structure of a multi-band planar antenna 30, 40. As shown in FIG. 4A and FIG. 4B, in each antenna, the shape and the size of the first radiation portion 32, 42 and the second radiation portion 34, 44 are similar, while the grounding portion 36, 46, the length is H₁ and H₂ respectively. In order to fulfill the expectation of the antenna size from different electronic device, the length H₁, H₂ of the grounding portion 36, 46 can be adjusted to adjust the overall size of each multi-band planar antenna 30, 40.

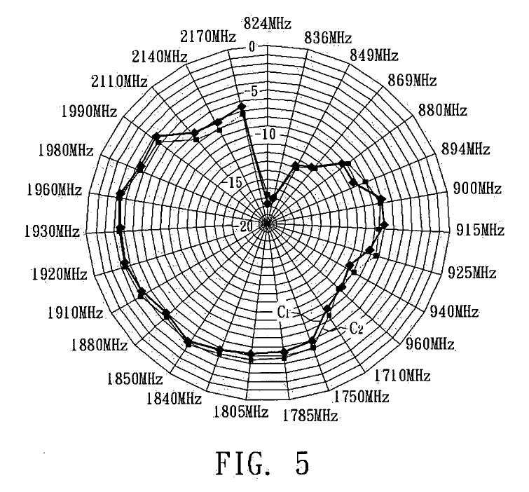

According to the research done by the inventor of present invention, adjusting the size of the grounding portion 36, 46 will not significantly alter the high frequency characteristic of multi-band planar antenna 30, 40. FIG. 5 illustrates the frequency gain relations diagram of the multi-band planar antenna 30, 40 in FIG. 4A and FIG. 4B. In FIG. 5, characteristic curve C₁ and characteristic curve C₁ are the frequency and power gain relations of multi-band planar antenna 30, 40 respectively. As illustrated in FIG. 5, there is no significant difference between characteristic curve C₁ and C₂, especially there is no shifting of transmitting/receiving band observed. In order to fulfill the high frequency characteristic specification required by the electronic device, the slight changes of the high frequency characteristic can be corrected by slightly adjusting the outlook of the first radiation portion 32, 42, second radiation portion 34, 44 and the grounding portion 36, 46. The slight outlook modification includes corner-truncated techniques.

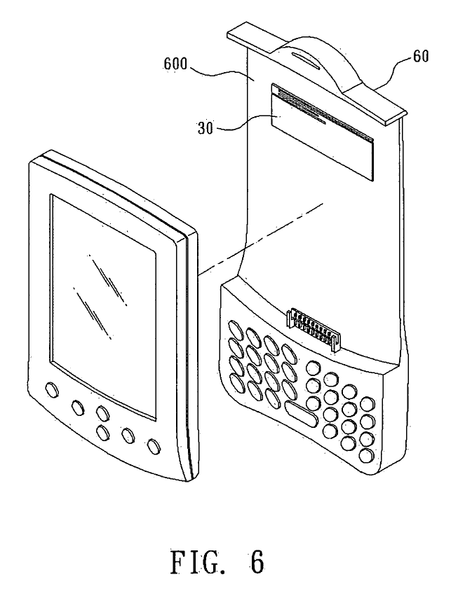

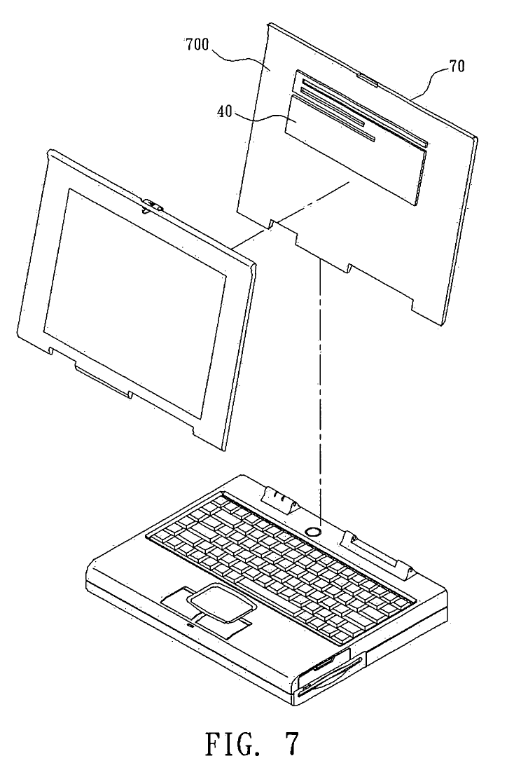

Besides, the multi-band planar antenna 30, 40 are suitable for different electronic device because of the difference in size. FIG. 6 and FIG. 7 illustrates the structure diagram of the electronic device 60, 70 respectively. Electronic device 60 is a portable communication device, while electronic device 70 is a portable laptop. As the electronic device 60, 70 having different structure and size, thus, they have different expectation on the structure and size of the antenna. As shown in FIG. 6 and FIG. 7, multi-band planar antenna 30, 40 fulfill the antenna size requirement of the electronic device 60, 70 respectively. So, multi-band planar antenna 30, 40 can be embedded into the shell 600, 700 of the electronic device 60, 70 respectively.

Based on the specification from FIG. 4A to FIG. 7, the step to adjust the size of multi-band planar antenna is as below:

First, provides a multi-band planar antenna 20;

Second, with regards to the assembly requirement, adjust the size of the grounding portion 26.

Therefore, without altering the microwave characteristic, the size of the multi-band planar antenna 20 can be adjusted to fulfill the antenna size requirement from the electronic device, without the need to redesign first radiation portion 22 and second radiation portion 24.

Based on the above description of the embodiment, the flat structure of the multi-band planar antenna revealed in present invention benefits its assembly with the electronic device. At the same time, in order to fulfill the antenna size requirement from different electronic device without incurring extra cost to design and manufacture new molds, the overall size of the antenna can be adjusted by adjusting the size of the grounding portion, without altering its high frequency characteristic. Thus, the multi-band antenna and the associated electronic device revealed by present invention can save the antenna design and manufacture cost to increase the product's competitiveness.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. An multi-band planar antenna, comprising:
a metal plate, comprising a first edge and second edge, wherein said first edge and said second edge are the two opposite edges of the metal plate respectively; a first radiation portion, said first radiation portion is configured on the upside of said metal plate by the first socket, and said first slot extends to the inner of said metal plate from said first edge; a second radiation portion, which is adjacent to said first radiation portion and configured on the upper side of the metal plate, said second radiation portion formed by a second slot and a third slot, wherein said second slot extends to the inner of the metal plate from said second edge and said third slot is formed between said first slot and said second slot; a grounding portion, being configured on the downside of said metal plate;
wherein said first radiation portion and said second radiation portion transmit and receive the low-band and the high-band of RF signal respectively.

2. The multi-band planar antenna as set forth in claim 1, wherein said low-band frequency is 900 MHz, and said high-band frequency is including 1800 MHz, 1900 MHz, 2100 MHz.

3. The multi-band planar antenna as set forth in claim 1, wherein the shape of said metal plate is in rectangle.

4. The multi-band planar antenna as set forth in claim 1, wherein said first slot, said second slot and third slot are rectangle slot and in parallel with each other.

5. The multi-band planar antenna as set forth in claim 4, wherein said first slot, said second slot and third slot are positioned as a straight line extending vertically from said first edge and said second edge.

6. The multi-band planar antenna as set forth in claim 1, comprising a feeding dot and a grounding dot, wherein the RF signals are transmitted/received via said feeding dot and said grounding dot.

7. The multi-band planar antenna as set forth in claim 6, wherein the position of said feeding dot is between said second slot and said third slot to transmit and receive RF signal.

8. The multi-band planar antenna as set forth in claim 6, wherein said grounding dot is on said grounding portion to be as the ground of said multi-band planar antenna.

9. An electronic device, comprising of a multi-band planar antenna as set forth in claim 1.

10. A method to adjust the size of the multi-band planar antenna as set forth in claim 1, said method including below steps:
providing said multi-band planar antenna;
adjusting the size of said grounding portion.
